(19) United States
(12) Patent Application Publication
(10) Pub. No.: US 2005/0249059 A1
(43) Pub. Date: Nov. 10, 2005

(54) Module for improving optical disc readability via dynamically adjusting optical focus position and method for the same

(76) Inventors: Hao-Yung Wang, Kao Hsiung City (TW); Chi-Chun Lo, Hsin Chu City (TW)

Correspondence Address: BIRCH STEWART KOLASCH & BIRCH, PO BOX 747, FALLS CHURCH, VA, 22040-0747, US

(21) Appl. No.: 10/944,190

(22) Filed: Sep. 20, 2004

(30) Foreign Application Priority Data
May 4, 2004 (TW) 93112518

(51) Int. Cl. G11B 7/00

(52) U.S. Cl. 369/44.27; 369/44.25; 369/53.23

(57) ABSTRACT

A module and method capable of dynamically adjusting the focus position for reading optical discs are described. The method includes: initializing the focus position; accessing data of the optical disk; determining whether an error occurred during data access; and dynamically adjusting the focus position. The module includes an optical drive unit, a detector and a control unit. The control unit includes a drive circuit, a sampler, a dynamic adjustment module and a microprocessor. The optical drive unit includes a light generator, a beam director, a focusing element, a mover and a relative mover. When the optical drive unit receives the signals reflected from the defect portion of the optical disk, the signals is passed to the detector to form an error signal, which is passed to the sampler to produce a sample signal and pass the sample signal to the dynamic adjustment module for adjusting the focus position.

### BACKGROUND OF THE INVENTION

1. Field of the Invention

The present invention is related to a module capable of dynamically adjusting an optical focus position and a method thereof, and more particularly, to a method that dynamically adjusts the optical focus position of a pickup head disposed inside a CD-ROM drive so as to make the pickup head capable of reading any kind of optical disc.

2. Description of Related Art

Conventionally, read-only optical disks and recordable optical disks are used to store digital data, i.e. a number of “0” and “1” digits. These digits are represented by some “pits” separated by some flat “lands”. These pits and lands are arranged spirally from the center to the periphery of the optical disks.

In order to access the optical disk, a laser beam is focused on the optical disk. If the laser beam is incident upon the “pits”, it is scattered. On the contrary, if the laser beam is incident upon the “lands”, it is reflected. Meanwhile, the optical disk drive, i.e. DVD-ROM drive, uses the reflected optical signals to retrieve the data recorded on the optical disk. Hence, the focus position of the laser beam greatly influences the data access result.

However, at the beginning of data access, the conventional method adjusts the position of the pickup head according to the signal quality and reflected signals. After that, the disk drive accesses the data of the optical disk according to the same focus position directly. As described in U.S. Pat. No. 5,574,706, “focus offset optimization for reading optically recorded data,” which is about the optimum focus offset for recording or accessing data on a optical disk, the position of the pickup head is adjusted according to pre-formatted control marks to achieve the optimum focus offset.

Reference is made to FIG. 1, which is a block diagram of a conventional optical disc drive. It includes an optical drive unit 10, a detector 12, a control unit 14 and an optical disk 16. The optical drive unit 10 further includes a light generator 100, a beam director 102, a focusing element 104, a mover 106 and a relative mover 108. The control unit 14 includes a sampler 140, a microprocessor 142 and a drive circuit 144.

During operation, the light generator 100 generates a laser beam and delivers it to the beam director 102. Then, the beam director 102 passes the laser beam to the focusing element 104 to focus the laser beam on the optical disk 16 and the signals reflected from the optical disk 16 are passed to the detector 12. Subsequently, the detector 12 generates a focusing servo error signal according to the laser beam reflected from the defect portion of the optical disk 16 and passes it to the sampler 140. The sampler 140 samples the error signal periodically. When receiving the error signal, the microprocessor 142 generates a signal to increase the focus offset via using the drive circuit 144 to control the mover 106 and the relative mover 108 to adjust the direction of the laser beam.

However, due to the deviation of the recording or manufacturing process of the optical disk, different focus positions are necessary for different portions of the optical disk to improve the readability of the optical disk. In the prior art mentioned above, the data of the optical disk cannot be accessed occasionally because the error signal has exceeded the predetermined tolerant region of the focus offset.

Accordingly, as discussed above, the prior art still has some drawbacks that could be improved upon. The present invention aims to resolve the drawbacks in the prior art.

### SUMMARY OF THE INVENTION

An objective of the present invention is to provide a module capable of dynamically adjusting an optical focus position and a method thereof. The present invention provides a method capable of dynamically adjusting an optical focus position according to the features of the pickup head. The adjustment range and magnitude depend on the features of the pickup head. Therein, the unit of the adjustment range and magnitude depends on the design of the focus control. The unit can be voltage, current, length, time, etc. If data access is smooth, it means the present focus position is correct and doesn't need to be changed. On the contrary, if the address decoding errors or data decoding errors occur in the data access, the present invention dynamically adjusts the focus position until the data access is back to normal.

Therefore, the present invention improves the readability of the optical disk via dynamically adjusting the focus position of the pickup head.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of a conventional optical disc drive;

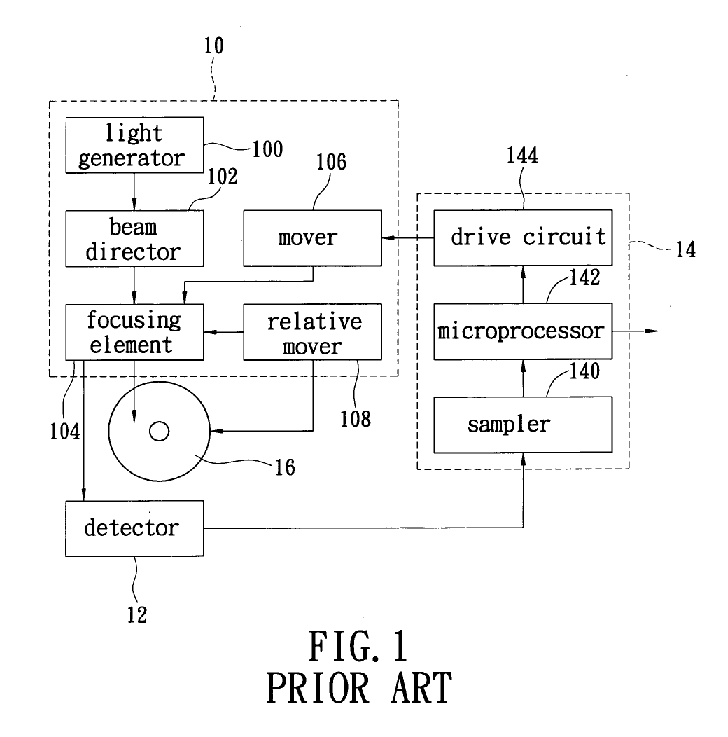

FIG. 2 is a block diagram of an optical disc drive with a module capable of dynamically adjusting the optical focus position in accordance with the present invention;

FIG. 3 is a flowchart of a method capable of dynamically adjusting the optical focus position in accordance with the present invention; and

FIG. 4 is a flowchart of another method capable of dynamically adjusting the optical focus position in accordance with the present invention.

### DETAILED DESCRIPTION OF PREFERRED EMBODIMENTS

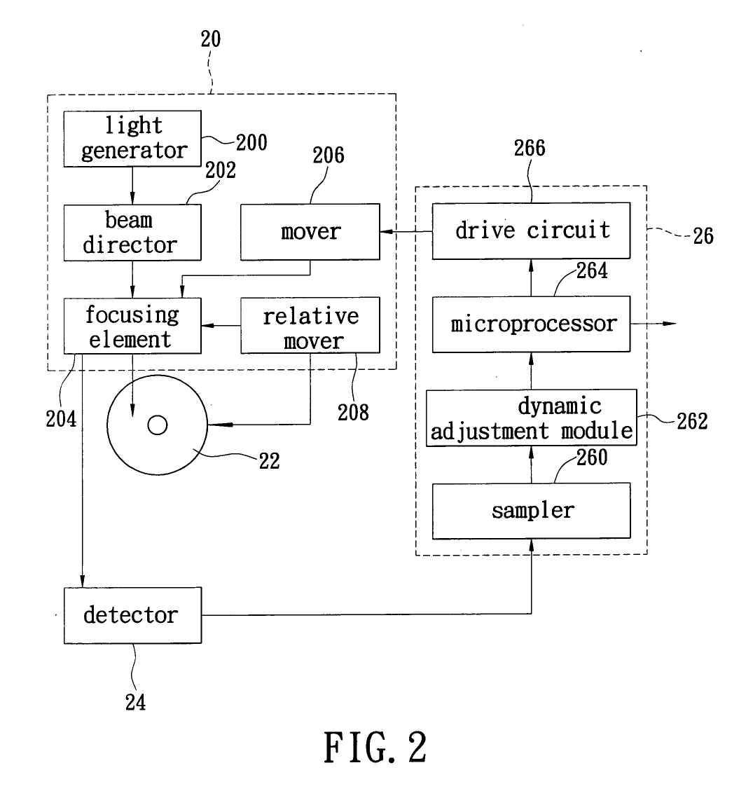

Reference is made to FIG. 2, which is a block diagram of an optical disc drive with a module capable of dynamically adjusting the optical focus position in accordance with the present invention. It includes an optical drive unit 20, an optical disk 22, a detector 24 and a control unit 26. The optical drive unit 20 further includes a light generator 200, a beam director 202, a focusing element 204, a mover 206 and a relative mover 208. The control unit 26 further includes a sampler 260, a dynamic adjustment module 262, a microprocessor 264 and a drive circuit 266.

During operation, the light generator 200 of the optical drive unit 20 generates a laser beam and delivers it to the beam director 202. Then, the beam director 202 passes the laser beam to the focusing element 204 to focus the laser beam on the optical disk 22 and the signals reflected from the optical disk 22 are passed to the detector 24. Subsequently, the detector 24 generates a focusing servo error signal according to the laser beam reflected from the defect portion of the optical disk 24 and passes it to the sampler 260. The sampler 260 samples the error signal periodically. When receiving the error signal, the dynamic adjustment module 262 generates a signal for the microprocessor 264 to dynamically adjust the focus offset via the drive circuit 266 to control the mover 206 and the relative mover 208 to adjust the direction of the laser beam.

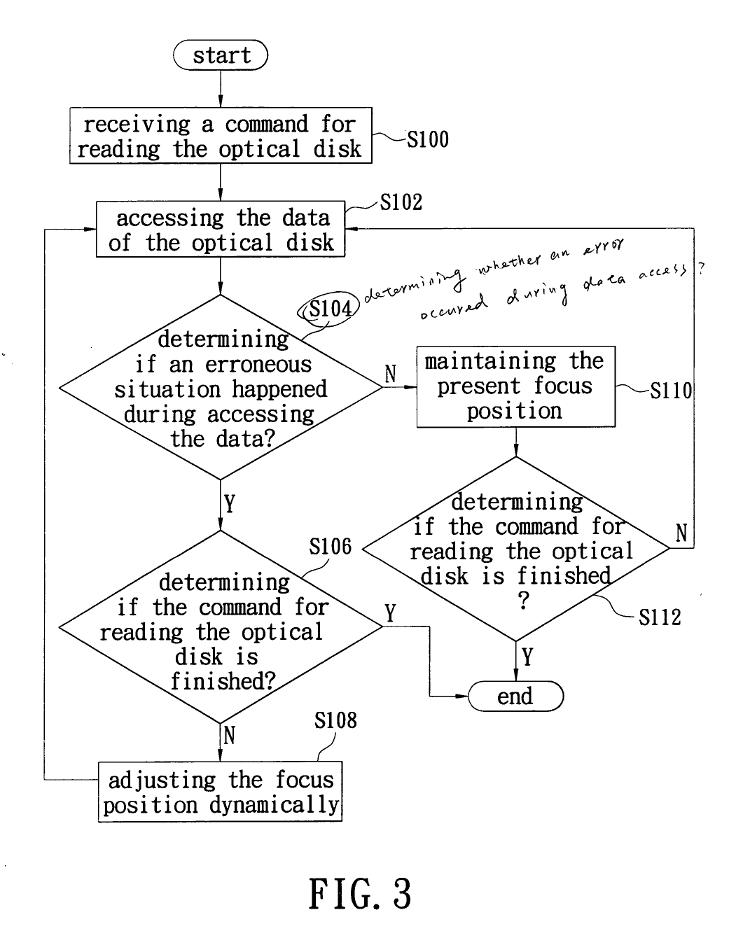

Reference is made to FIG. 3, which is a flowchart of a method capable of dynamically adjusting the optical focus position in accordance with the present invention. It includes: receiving a command for reading the optical disk (S100) and accessing the data of the optical disk (S102); determining whether an error occurred during data access (S104); if yes, determining if the command for reading the optical disk is finished (S106); and if no, maintaining the present focus position (S110) and then determining if the command for reading the optical disk is finished (S112). If the result of step S112 is yes, the whole process is finished; otherwise, the process returns to step S102.

In step S106, if the result is yes, the whole process is finished; otherwise, the focus position is dynamically adjusted (S108) and the process returns to step S102. The whole process is finished after the command for reading the optical disk is finished.

In the method of the present invention, every portion of the optical disk can be read via dynamically adjusting the focus position. The optical disk can be divided into several regions and each of the focus positions of the regions can be stored. Thus, most of the regions can be accessed smoothly. However, some connecting regions may not be accessed smoothly due to the size limit of the divided regions. The present invention will dynamically adjust the focus position for these connecting regions again.

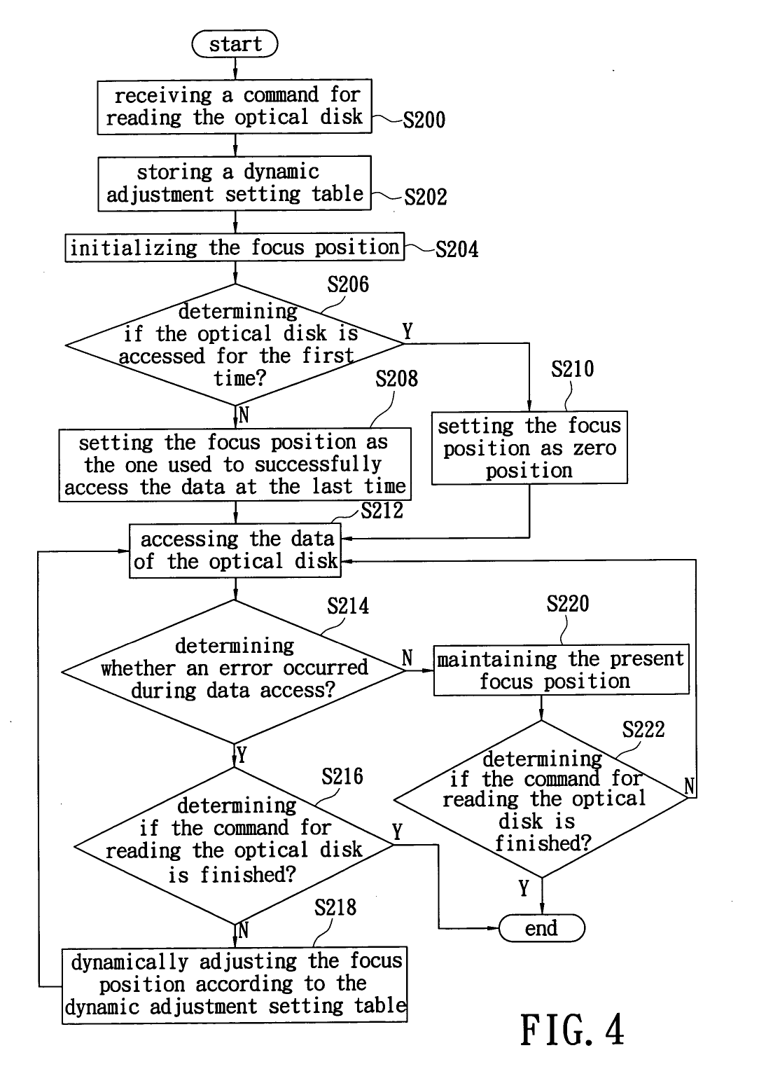

Reference is made to FIG. 4, which is a flowchart of another method capable of dynamically adjusting the optical focus position in accordance with the present invention. It includes: receiving a command for reading the optical disk (S200); storing a dynamic adjustment setting table (S202); initializing the focus position (S204); determining if the optical disk is accessed for the first time (S206); if yes, setting the focus position at zero position (S210) and then accessing the data of the optical disk (S212); if no, setting the focus position as the last one used to access the data successfully (S208) and then accessing the data of the optical disk (S212); subsequently, determining whether an error occurred during data access (S214); if the result of step S214 is yes, determining whether the command for reading the optical disk is finished (S216); if the result of step S216 is no, dynamically adjusting the focus position according to the dynamic adjustment setting table (S218) and then returning to step S212; if the result of step S216 is yes, ending the whole process.

If the result of step S214 is no, the present invention maintains the present focus position (S220) and then determines whether the command for reading the optical disk is finished (S222). If the result of step S222 is yes, the whole process is finished; otherwise, the process returns to step S212.

In the embodiment of the present invention, the zero position means the focus position initially adjusted according to the signal quality and the reflected signals. The adjustment direction of the focus position can be a “positive direction” or “negative direction”. The “positive direction” means to move the focus position upwardly from the zero position. On the contrary, the “negative direction” means to move the focus position downward. The movement magnitude is proportional to the unit being used.

For instance, if the adjustment range is located between −8 and +8 units, the method of the present invention first adjusts the focus position in the “positive direction” by increasing 4 units each time. So, the focus position starts from 0, moves to +4, and then moves to +8. After reaching the adjustment margin (i.e., +8), the present invention adjusts the focus position in the “negative direction,” first by decreasing 2 units, and then by decreasing 4 units each time. So, the focus position moves from +8, to +6, then to +2, −2, and finally to −6. Then the focus position moves from −6 to −8 (adjustment margin), and moves in the “positive direction” to −4 and finally to 0. In short, the focus position follows an adjustment cycle as follows: 0, +4, +8, +6, +2, −2, −6, −8, −2, 0, and the cycle repeats again. The focus position of the pickup head can thereby be dynamically adjusted between −8 and 8 units according to the situation of disk reading. The physical unit of the adjustment range can be, for example, voltage, current, length or time, depending on the design of the focus control for the pickup head.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A method for improving readability of an optical disc via dynamically adjusting a focus position, comprising:
receiving a command for reading the optical disk;
accessing data recorded on the optical disk;
determining whether an error occurred during data access; and
adjusting the focus position dynamically to access data of the optical disk.

2. The method as claimed in claim 1, wherein the step of determining whether the error occurred during data access further comprises:
determining if the command for reading the optical disk is finished.

3. The method as claimed in claim 1, wherein the step of determining whether the error occurred during data access further comprises the following steps if a result of the step of determining whether the error occurred during data access is no:
maintaining the present focus position; and
determining if the command for reading the optical disk is finished;
wherein the method performs the step of adjusting the focus position dynamically to access the data of the optical disk if the result of the step of determining whether the error occurred during data access is yes.

4. The method as claimed in claim 2, wherein the step of determining if the command for reading the optical disk is finished further comprises:
ending the method if a result of the step of determining if the command for reading the optical disk is finished is yes;
wherein the method performs the step of adjusting the focus position dynamically to access the data of the optical disk if the result of the step of determining if the command for reading the optical disk is finished is no.

5. The method as claimed in claim 3, wherein the step of determining if the command for reading the optical disk is finished further comprises:
ending the method if a result of the step of determining if the command for reading the optical disk is yes;
wherein the method performs the step of accessing the data recorded on the optical disk if the result of the step of determining if the command for reading the optical disk is no.

6. A method for improving a readability of an optical disc via dynamically adjusting a focus position, comprising:
receiving a command for reading the optical disk;
storing a dynamic adjustment setting table;
determining if the optical disk is accessed for the first time; and
setting the focus position the same as the last focus position used to successfully access data of the optical disk.

7. The method as claimed in claim 6, wherein the step of storing the dynamic adjustment setting table further comprises:
initializing the focus position.

8. The method as claimed in claim 6, wherein the method performs the step of setting the focus position the same as the last focus position used to successfully access data of the optical disk if a result of the step of determining if the optical disk is accessed for the first time is no, and the method sets the focus position the same as a zero position if the result of the step of determining if the optical disk is accessed for the first time is yes.

9. The method as claimed in claim 8, wherein in the step of setting the focus position the same as the zero position, the zero position is the focus position initially adjusted according to a signal quality and reflected signals.

10. The method as claimed in claim 9, wherein an adjustment direction of the focus position is a positive direction or a negative direction.

11. The method as claimed in claim 10, wherein moving in the positive direction is to move the focus position upwardly from the zero position.

12. The method as claimed in claim 10, wherein moving in the negative direction is to move the focus position downward from the zero position.

13. The method as claimed in claim 6, wherein the step of setting the focus position comprises:
accessing the data recorded on the optical disk;
determining whether an error occurred during data access;
determining if the command for reading the optical disk is finished; and
adjusting the focus position according to the dynamic adjustment setting table.

14. The method as claimed in claim 13, wherein if a result of determining whether the error occurred during data access is yes, the method performs the step of determining if the command for reading the optical disk is finished, and if the result of determining whether the error occurred during data access is no, the method further comprises:
maintaining the present focus position; and
determining if the command for reading the optical disk is finished.

15. The method as claimed in claim 13, wherein the step of determining if the command for reading the optical disk is finished further comprises:
ending the method if a result of the step of determining if the command for reading the optical disk is finished is yes;
wherein the method performs the step of adjusting the focus position according to the dynamic adjustment setting table if the result of the step of determining if the command for reading the optical disk is finished is no.

16. The method as claimed in claim 14, wherein the step of determining if the command for reading the optical disk is finished further comprises:
ending the method if a result of the step of determining if the command for reading the optical disk is yes;
wherein the method performs the step of accessing the data recorded on the optical disk if the result of the step of determining if the command for reading the optical disk is no.

17. A module for improving a readability of an optical disc via dynamically adjusting a focus position, comprising:
an optical drive unit comprising a focusing element to read data from the optical disc;
a detector used to receive a signal from the optical drive unit; and
a control unit used to receive a signal of the detector and dynamically adjust the focusing element.

18. The module as claimed in claim 17, wherein the optical drive unit further comprises:
a light generator used to generate a laser beam;
a beam director used to direct the laser beam generated by the light generator to a recording layer of the optical disc;
a mover used to control a moving direction and a position of the focusing element; and
a relative mover used to provide a relative movement of the focusing element and the recording layer of the optical disc in a parallel direction.

19. The module as claimed in claim 17, wherein the control unit further comprises:
a drive circuit;
a sampler used to receive the signal of the detector and provide sampling signals in an electric wave manner;
a dynamic adjustment module used to receive the sampling signals from the sampler and dynamically adjust the focus position according to the sampling signals; and
a microprocessor used to receive an adjusting signal from the dynamic adjustment module and drive the drive circuit to control the mover and relative mover according to the adjusting signal to direct the laser beam to access a disc track after the focus position is adjusted.

20. The module as claimed in claim 19, wherein the dynamic adjustment module adjusts the focus position according to an adjustment range and a physical unit.

21. The module as claimed in claim 20, wherein the physical unit is a voltage, a current, a length or a time period.
